(19) United States
(12) Patent Application Publication
(10) Pub. No.: US 2025/0106834 A1
(43) Pub. Date: Mar. 27, 2025

(54) SEMI-PERSISTENT CHANNEL STATE INFORMATION REPORT REFINEMENT

(71) Applicant: QUALCOMM INCORPORATED, San Diego, CA (US)

(72) Inventors: Mahmoud Taherzadeh Boroujeni, San Diego, CA (US); Tao Luo, San Diego, CA (US); Qiaoyu Li, Beijing (CN); Kiran Venugopal, Green Brook, NJ (US); Peter Gaal, San Diego, CA (US); Junyi Li, Greentown, PA (US); Iyab Issam Sakhnini, San Diego, CA (US); Juan Montojo, San Diego, CA (US)

(21) Appl. No.: 18/729,481

(22) PCT Filed: Mar. 23, 2022
(86) PCT No.: PCT/CN2022/082390

§ 371 Date: Jul. 16, 2024

(51) Int. Cl. H04W 72/11; H04B 7/06; H04L 5/00

(52) U.S. Cl. CPC H04W 72/11; H04B 7/0626; H04L 5/0051

(57) ABSTRACT

Methods, systems, and devices for wireless communications are described. The method may include a user equipment (UE) receiving, from a network node, a message that indicates for the UE to generate a periodic channel state information (CSI) report including refinement information with respect to a previously CSI report. The UE may receive one or more demodulation reference signals (DMRSs) during one or more semi-persistent scheduling (SPS) occasions and generate the CSI report, where the refinement information included in the CSI report is based on measurements of the received one or more DMRSs. The UE may then transmit the CSI report to the network node.

CROSS REFERENCE

The present Application is a 371 national stage filing of International PCT Application No. PCT/CN2022/082390 by Taherzadeh Boroujeni et al. entitled “SEMI-PERSISTENT CHANNEL STATE INFORMATION REPORT REFINEMENT,” filed Mar. 23, 2022, which is assigned to the assignee hereof, and which is expressly incorporated by reference in its entirety herein.

### TECHNICAL FIELD

The following relates generally to wireless communications, and more specifically to semi-persistent (SP) channel state information (CSI) report refinement.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a UE may transmit a channel state information (CSI) report to a base station. The CSI report may include parameters such as a channel quality indicator (CQI), a precoding matrix indicator (PMI), or a rank indicator (RI) that the base station may utilize for various purposes (e.g., beamforming or modulation coding scheme (MCS) selection). In some examples, the UE may generate the CSI report based on one or more CSI-reference signals (CSI-RS) or one or more synchronization signal block (SSB) signals received from the base station. That is, the UE may measure the one or more CSI-RSs or the one or more SSB signals and determine the CSI based on the measurements.

### SUMMARY

The described techniques relate to improved methods, systems, devices, and apparatuses that support semi-persistent (SP) channel state information (CSI) report refinement. Generally, the described techniques provide for a user equipment (UE) transmitting an SP CSI report to a base station including refinement information with respect to a previously transmitted CSI report. The UE may receive a message from the base station indicating that the UE is to generate the SP CSI report. Upon receiving the message, the UE may receive one or more demodulation reference signals (DMRSs) from the base station during one or more semi-persistent scheduling (SPS) occasions and generate the SP CSI report based on measurements made of the one or more DMRSs. The UE may then transmit the SP CSI report including the refinement information to the base station.

A method for wireless communication at a UE is described. The method may include receiving, from a network entity, a message indicating that the UE is to generate a periodic CSI report that includes refinement information with respect to a previously transmitted CSI report, receiving, from the network entity, one or more DMRSs during one or more SPS occasions of a set of multiple SPS occasions, and transmitting, to the network entity, the periodic CSI report that includes the refinement information, where the refinement information is based on measurements made of the one or more DMRSs.

An apparatus for wireless communication at a UE is described. The apparatus may include at least one processor and memory coupled (e.g., operatively, communicatively, functionally, electronically, or electrically) to the at least one processor, the memory storing instructions executable by the at least one processor to cause the apparatus to receive, from a network entity, a message indicating that the UE is to generate a periodic CSI report that includes refinement information with respect to a previously transmitted CSI report, receive, from the network entity, one or more DMRSs during one or more SPS occasions of a set of multiple SPS occasions, and transmit, to the network entity, the periodic CSI report that includes the refinement information, where the refinement information is based on measurements made of the one or more DMRSs.

Another apparatus for wireless communication at a UE is described. The apparatus may include means for receiving, from a network entity, a message indicating that the UE is to generate a periodic CSI report that includes refinement information with respect to a previously transmitted CSI report, means for receiving, from the network entity, one or more DMRSs during one or more SPS occasions of a set of multiple SPS occasions, and means for transmitting, to the network entity, the periodic CSI report that includes the refinement information, where the refinement information is based on measurements made of the one or more DMRSs.

A non-transitory computer-readable medium storing code for wireless communication at a UE is described. The code may include instructions executable by at least one processor to receive, from a network entity, a message indicating that the UE is to generate a periodic CSI report that includes refinement information with respect to a previously transmitted CSI report, receive, from the network entity, one or more DMRSs during one or more SPS occasions of a set of multiple SPS occasions, and transmit, to the network entity, the periodic CSI report that includes the refinement information, where the refinement information is based on measurements made of the one or more DMRSs.

In some examples of the method, apparatuses, and non-transitory computer-readable medium described herein, receiving the message indicating that the UE may be to generate the periodic CSI report may include operations, features, means, or instructions for receiving signaling that indicates a configuration for the set of multiple SPS occasions, where the configuration includes the message indicating that the UE may be to generate the periodic CSI report.

In some examples of the method, apparatuses, and non-transitory computer-readable medium described herein, receiving the message indicating that the UE may be to generate the periodic CSI report may include operations, features, means, or instructions for receiving signaling indicating a periodicity for transmission of the periodic CSI report.

Some examples of the method, apparatuses, and non-transitory computer-readable medium described herein may further include operations, features, means, or instructions for determining a first periodicity for transmission of the periodic CSI report, the first periodicity based on a second periodicity of the set of multiple SPS occasions and a scaling factor to be applied to the second periodicity.

Some examples of the method, apparatuses, and non-transitory computer-readable medium described herein may further include operations, features, means, or instructions for generating the periodic CSI report based on measurements made of the one or more DMRSs during a single SPS occasion of the set of multiple SPS occasions.

Some examples of the method, apparatuses, and non-transitory computer-readable medium described herein may further include operations, features, means, or instructions for generating the periodic CSI report based on measurements made of the one or more DMRSs during two or more SPS occasions of the set of multiple SPS occasions.

In some examples of the method, apparatuses, and non-transitory computer-readable medium described herein, transmitting the periodic CSI report may include operations, features, means, or instructions for transmitting the periodic CSI report during a resource allocated for feedback for data signaling received during the one or more SPS occasions.

In some examples of the method, apparatuses, and non-transitory computer-readable medium described herein, transmitting the periodic CSI report may include operations, features, means, or instructions for transmitting the periodic CSI report during a slot that may be offset, via an offset value, from one of the one or more SPS occasions or a feedback occasion associated with the one or more SPS occasions.

Some examples of the method, apparatuses, and non-transitory computer-readable medium described herein may further include operations, features, means, or instructions for generating the periodic CSI report based on measurements of the one or more DMRSs that may be associated with successful receipt of downlink signaling received during the one or more SPS occasions.

Some examples of the method, apparatuses, and non-transitory computer-readable medium described herein may further include operations, features, means, or instructions for measuring at least two DMRSs received during the one or more SPS occasions and combining the measurements of the at least two DMRSs, where the refinement information may be based on the combining.

In some examples of the method, apparatuses, and non-transitory computer-readable medium described herein, combining the measurements of the at least two DMRSs may include operations, features, means, or instructions for averaging the measurements of the at least two DMRSs and applying a temporal filter to the measurements of the at least two DMRSs.

Some examples of the method, apparatuses, and non-transitory computer-readable medium described herein may further include operations, features, means, or instructions for measuring one or more downlink signals in addition to the one or more DMRSs during the one or more SPS occasions and generating the periodic CSI report based on first measurements made of the one or more downlink signals and on second measurements made of the one or more DMRSs, where inclusion of the first measurements in generation of the periodic CSI report may be based on a condition being satisfied.

In some examples of the method, apparatuses, and non-transitory computer-readable medium described herein, the condition includes a first value of a parameter, the first value associated with the one or more downlink signals, being equal to a second value of the parameter, the second value associated with the one or more DMRSs, the parameter including a transmission configuration state, a type of precoding, or an antenna port.

In some examples of the method, apparatuses, and non-transitory computer-readable medium described herein, the refinement information includes a quantity of bits, the quantity of bits indicating a differential adjustment of a parameter with respect to a value of the parameter indicated in the previously transmitted CSI report and the previously transmitted CSI report may be one of a previous periodic report transmitted in accordance with the message or a previous report transmitted in accordance with a CSI configuration separate from the message.

In some examples of the method, apparatuses, and non-transitory computer-readable medium described herein, the refinement information indicates refinement of a channel quality index (CQI) or a reference signal received power (RSRP) report.

Some examples of the method, apparatuses, and non-transitory computer-readable medium described herein may further include operations, features, means, or instructions for generating the periodic CSI report based on an absence of precoding diversity schemes being applied to the one or more SPS occasions.

A method for wireless communication at a network entity is described. The method may include outputting a message indicating that a UE is to generate a periodic CSI report that includes refinement information with respect to a previously received CSI report, outputting one or more DMRSs during one or more SPS occasions of a set of multiple SPS occasions, and obtaining the periodic CSI report that includes the refinement information, where the refinement information is based on measurements made of the one or more DMRSs.

An apparatus for wireless communication at a network entity is described. The apparatus may include at least one processor and memory coupled (e.g., operatively, communicatively, functionally, electronically, or electrically) to the at least one processor, the memory storing instructions executable by the at least one processor to cause the apparatus to output a message indicating that a UE is to generate a periodic CSI report that includes refinement information with respect to a previously received CSI report, output one or more DMRSs during one or more SPS occasions of a set of multiple SPS occasions, and obtain the periodic CSI report that includes the refinement information, where the refinement information is based on measurements made of the one or more DMRSs.

Another apparatus for wireless communication at a network entity is described. The apparatus may include means for outputting a message indicating that a UE is to generate a periodic CSI report that includes refinement information with respect to a previously received CSI report, means for outputting one or more DMRSs during one or more SPS occasions of a set of multiple SPS occasions, and means for obtaining the periodic CSI report that includes the refinement information, where the refinement information is based on measurements made of the one or more DMRSs.

A non-transitory computer-readable medium storing code for wireless communication at a network entity is described. The code may include instructions executable by at least one processor to output a message indicating that a UE is to generate a periodic CSI report that includes refinement information with respect to a previously received CSI report, output one or more DMRSs during one or more SPS occasions of a set of multiple SPS occasions, and obtain the periodic CSI report that includes the refinement information, where the refinement information is based on measurements made of the one or more DMRSs.

In some examples of the method, apparatuses, and non-transitory computer-readable medium described herein, outputting the message indicating that the UE may be to generate the periodic CSI report may include operations, features, means, or instructions for transmitting signaling indicating a configuration for the set of multiple SPS occasions, where the configuration includes the message indicating that the UE may be to generate the periodic CSI report.

In some examples of the method, apparatuses, and non-transitory computer-readable medium described herein, outputting the message indicating that the UE may be to generate the periodic CSI report may include operations, features, means, or instructions for transmitting signaling indicating a periodicity for transmission of the periodic CSI report.

In some examples of the method, apparatuses, and non-transitory computer-readable medium described herein, a first periodicity for transmission of the periodic CSI report may be based on a second periodicity of the set of multiple SPS occasions and a scaling factor to be applied to the second periodicity.

In some examples of the method, apparatuses, and non-transitory computer-readable medium described herein, the message further indicates that the UE may be to generate the periodic CSI report based on measurements made of one or more DMRSs during a single SPS occasion of the set of multiple SPS occasions.

In some examples of the method, apparatuses, and non-transitory computer-readable medium described herein, the message further indicates that the UE may be to generate the periodic CSI report based on measurements made of one or more DMRSs during two or more SPS occasions of the set of multiple SPS occasions.

In some examples of the method, apparatuses, and non-transitory computer-readable medium described herein, obtaining the periodic CSI report may include operations, features, means, or instructions for receiving the periodic CSI report during a resource allocated for feedback of data signaling received during the one or more SPS occasions.

In some examples of the method, apparatuses, and non-transitory computer-readable medium described herein, obtaining the periodic CSI report may include operations, features, means, or instructions for receiving the periodic CSI report during a slot that may be offset, via a slot offset, from one or more of the one or more SPS occasions or from a feedback occasion associated with the one or more SPS occasions.

In some examples of the method, apparatuses, and non-transitory computer-readable medium described herein, the message further indicates that the UE may be to generate the periodic CSI report based on measurements of the one or more DMRSs that may be associated with successful receipt of downlink signaling received during one or more SPS occasions.

In some examples of the method, apparatuses, and non-transitory computer-readable medium described herein, the refinement information includes a quantity of bits, the quantity of bits indicating a differential adjustment of a parameter with respect to a value of the parameter indicated in the previously received CSI report and the previously received CSI report may be one of a previous periodic report received in accordance with the message or a previous report received in accordance with a CSI configuration separate from the message.

In some examples of the method, apparatuses, and non-transitory computer-readable medium described herein, the refinement information indicates refinement of a CQI or a reference signal received power (RSRP) report.

### BRIEF DESCRIPTION OF THE DRAWINGS

FIGS. 1 and 2 illustrate examples of a wireless communications system that supports semi-persistent (SP) channel state information (CSI) report refinement in accordance with aspects of the present disclosure.

FIG. 3 illustrates an example of a transmission scheme that supports SP CSI report refinement in accordance with aspects of the present disclosure.

FIG. 4 illustrates an example of a process flow that supports SP CSI report refinement in accordance with aspects of the present disclosure.

FIGS. 5 and 6 show block diagrams of devices that support SP CSI report refinement in accordance with aspects of the present disclosure.

FIG. 7 shows a block diagram of a communications manager that supports SP CSI report refinement in accordance with aspects of the present disclosure.

FIG. 8 shows a diagram of a system including a device that supports SP CSI report refinement in accordance with aspects of the present disclosure.

FIGS. 9 and 10 show block diagrams of devices that support SP CSI report refinement in accordance with aspects of the present disclosure.

FIG. 11 shows a block diagram of a communications manager that supports SP CSI report refinement in accordance with aspects of the present disclosure.

FIG. 12 shows a diagram of a system including a device that supports SP CSI report refinement in accordance with aspects of the present disclosure.

FIGS. 13 through 16 show flowcharts illustrating methods that support SP CSI report refinement in accordance with aspects of the present disclosure.

### DETAILED DESCRIPTION

A user equipment (UE) may report channel state information (CSI) to a base station. Examples of information that may be included in a CSI report are a channel quality indicator (CQI) or an L1-reference signal received power (L1-RSRP) report. The UE may determine the information based on measurements made of received synchronization signal block (SSB) signals or received CSI reference signals (CSI-RSs). SSBs or CSI-RSs may be transmitted by a base station in accordance with a regular pattern (e.g., dynamically scheduled). Thus, a UE may report CSI at some intervals linked to the periodicity of the SSBs or CSI-RSs. More frequent CSI reporting may be desired. As such, a UE may receive an instruction from a base station to determine an updated CSI report based on measurements made of some other signal, such as a demodulation reference signal (DMRS) associated with a downlink message. Such DMRS-based CSI refinement may be problematic as the DMRSs and associated downlink messages are generally aperiodic and may occupy a variety of different resources, meaning that the CSI determined from the DMRS may not be comparable to the more regularly-determined CSI.

The UE may operate in accordance with a semi-persistent scheduling (SPS) configuration. SPS may allow the UE to receive downlink data transmissions on periodically-scheduled resources. Each set of periodically-scheduled resources may be an SPS resource set. When an SPS resource set is activated, the UE may also be activated to make CSI measurements of the DMRSs associated with the activated SPS resource set. Because the DMRSs are periodically received on a recurring set of resources, the CSI determined based on these DMRS measurements is well-positioned to be included in CSI refinement reports (reports that refine the CSI with respect to a previous report). Thus, a UE may transmit a refined CSI report to the base station using measurements of DMRSs received during SPS occasions. The UE may receive a configuration for the CSI reporting, where the configuration is included in an SPS configuration. A periodicity of the CSI reporting may be included in the configuration messaging or may be determined in accordance with a rule. The periodicity may be the same or different than the periodicity of the SPS occasions. In the case that the UE reports the refined CSI every few SPS occasions, the UE may use utilize DMRS measurements of different SPS occasions and then combine the measurements.

Aspects of the disclosure are initially described in the context of wireless communications systems. Additional aspects of the disclosure are described in the context of a transmission scheme and a process flow. Aspects of the disclosure are further illustrated by and described with reference to apparatus diagrams, system diagrams, and flowcharts that relate to SP CSI report refinement.

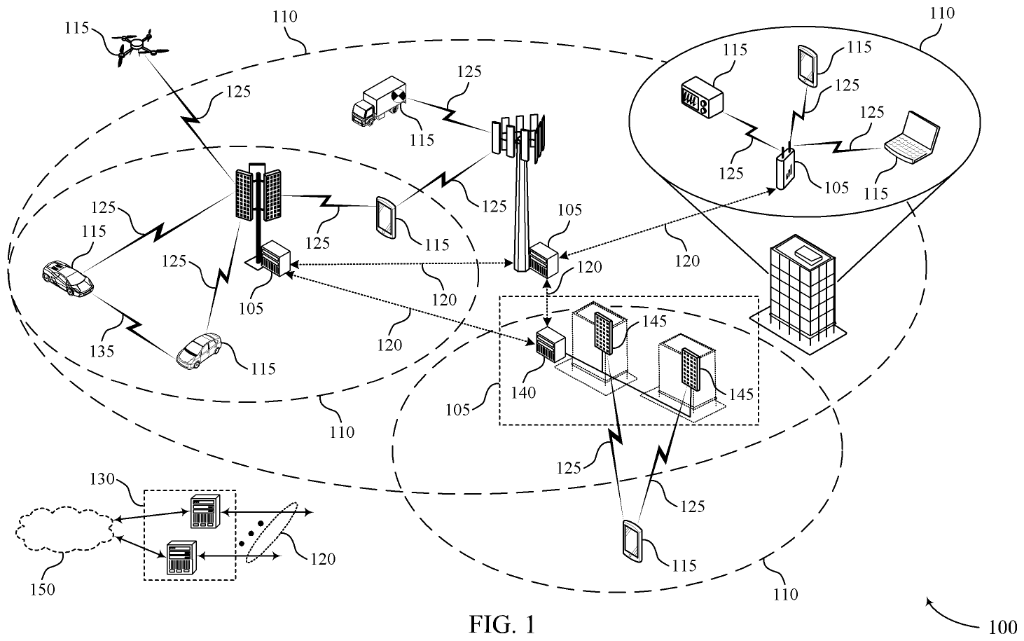

FIG. 1 illustrates an example of a wireless communications system 100 that supports SP CSI report refinement in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS, which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the UE 115 may transmit a semi-persistent (SP) CSI report to the base station 105 including refinement information with respect to a previously transmitted CSI report. The UE 115 may receive a message from the base station 105 indicating that the UE 115 is to generate the SP CSI report. Upon receiving the message, the UE 115 may receive one or more demodulation reference signals (DMRSs) from the base station 105 during one or more SPS occasions and generate the SP CSI report based on measurements made of the one or more DMRSs. The UE 115 may then transmit the SP CSI report including the refinement information to the base station.

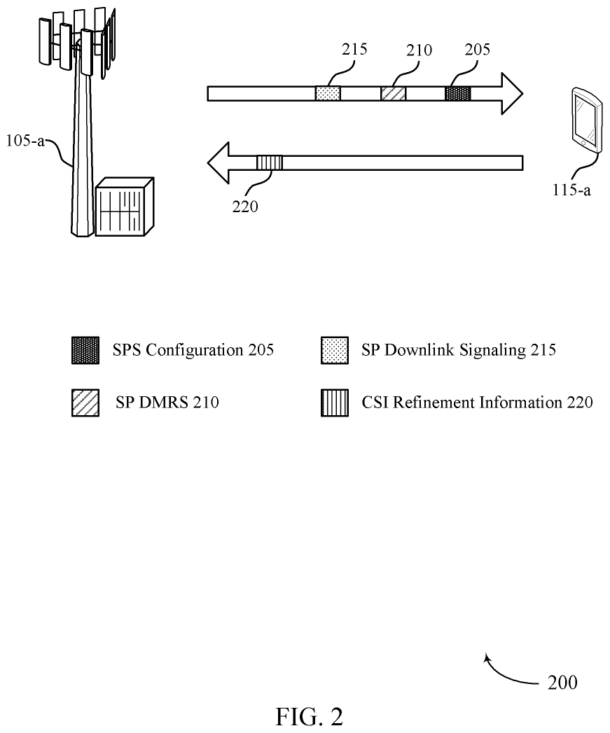

FIG. 2 illustrates an example of a wireless communication system 200 that supports SP CSI report refinement in accordance with aspects of the present disclosure. In some examples, the wireless communications system 200 may implement aspects of a wireless communications system 100. For example, the wireless communications system 200 may include a base station 105-a and a UE 115-a which may be examples of a base station 105 and a UE 115 as described with reference to FIG. 1.

In some examples, the wireless communications system 200 may implement SPS. To implement SPS, the base station 105-a may transmit an SPS configuration 205 to the UE 115-a. In some examples, the base station 105-a may provide the SPS configuration 205 to the UE 115-a via RRC signaling. In some examples, the SPS configuration 205 may include information associated with SPS. For example, the SPS configuration 205 may include an indication of a periodicity for SPS. The periodicity for SPS may refer to a number of subframes between each SPS occasion. Merely configuring the UE 115-a with SPS may not allow the UE 115-a to immediately utilize SPS. Instead, SPS may be activated or deactivated at the UE 115-a via control signaling (e.g., downlink control information (DCI)) from the base station 105-a. Once activated, the UE 115-a may utilize a resource grant indicated in the control signaling according to the SPS configuration 205 until SPS is deactivated. That is, the UE 115-a may apply the resource grant to each SPS occasion.

SPS may be configured in the uplink direction as well as the downlink direction. In the case of downlink SPS, the SPS configuration 205 may also include a number of configured HARQ processes as well as a transmit power control (TPC) command for uplink control channel signaling. In some examples, the UE 115-a may use the TPC command to determine resources for HARQ feedback responsive to the SPS downlink transmissions. For example, the UE 115-a may use the TPC command as an index to a resource value configured by RRC. Along with SPS, the wireless communications system 200 may implement dynamic scheduling. Unlike SPS, dynamic scheduling may allow the UE 115-a to obtain a resource grant in every subframe instead of receiving a resource grant every few subframes as is the case with SPS. For example, in dynamic scheduling, the UE 115-a may receive the resource grant in a subframe and utilize the resource grant in that subframe only.

In some examples, the UE 115-a may report CSI to the base station 105-a in a CSI report. CSI information may include one or more of a CQI, a PMI, a CSI-RS resource indicator (CRI), an synchronization signaling/physical broadcast channel resource block indicator (SSBRI), a layer indicator (LI), a rank indicator (RI), or an L1-RSRP report. The base station 105-a may use the CSI for various purposes. In one example, the base station 105-a may utilize the CSI (e.g., the CQI) to determine a MCS to use with the UE 115-a. In another example, the UE 115-a may use the CSI (e.g., L1-RSRP report) to select a beam pair for communication with the UE 115-a. In some examples, the UE 115-a may determine CSI based on measurements of SSB signals or CSI-RSs. That is, the UE 115-a may perform measurements on received SSB signals or CSI-RS signals, determine the CSI using the measurements, and transmit the CSI to the base station 105-a in the CSI report. In some examples, the UE 115-a may report CSI at a relatively low periodicity to reduce a number of SSB signal and CSI-RS resources allocated to the UE 115-a in an effort to increase resource efficiency. However, a downlink channel between the UE 115-a and the base station 105-a may change drastically over time and reporting CSI at the low periodicity may not allow for the UE 115-a to report the most accurate and recent CSI to the base station 105-a. However, reporting CSI at a relatively high periodicity may result in a decrease resource efficiency.

In some examples, the UE 115-a may transmit a refined CSI report that includes an indication of an adjustment to a parameter (e.g., the CQI) included a previously transmitted CSI report. The UE 115-a may measure DMRSs of dynamically scheduled downlink signals and generate the refined CSI report based on the measurements. The UE 115-a may then transmit the refined CSI report together with feedback information associated with the downlink signals. But transmitting the refined CSI report along with the feedback information may change or increase a size of uplink control information (UCI) transmitted to the base station 105-a resulting in a unique or different physical uplink control channel (PUCCH) resource set. The PUCCH resource set may be set or configured for the UE 115-a. As such, additional signaling may be introduced to account for the changing size which may increase overhead signaling. In some examples, the feedback information and the refined CSI report may be transmitted separately. But such approach may result in one-to-one mapping between a physical downlink shared channel (PDSCH) and the refined CSI report which may result in an inefficient use of resources.

As described herein, the base station 105-a may configure the UE 115-a with a periodic or SP CSI report that carries CSI refinement information 220 with respect to a previously transmitted CSI report. In some examples, the base station 105-a may transmit a periodic CSI report configuration message configuring the UE 115-a with the periodic CSI report. In one example, the periodic CSI report configuration message may include an indication of a periodicity of the periodic CSI report. The periodicity may indicate how often to transmit the periodic CSI report. In one example, the periodicity may be based on the periodicity of the SPS. That is, the periodicity may indicate to transmit the periodic CSI report in every SPS occasion. Alternatively, the periodicity may be based on a periodicity of the SPS and a scaling factor. As one example, the scaling factor may be two. In such case, the UE 115-a may report the periodic CSI report in every other SPS occasion. In some examples, the periodic CSI report configuration message may be signaled to the UE 115-a as part of the SPS configuration 205.

In some examples, the UE 115-a may identify resources over which to transmit the periodic CSI report including the CSI refinement information 220. In one example, the UE 115-a may transmit the periodic CSI report over resources allocated for SPS HARQ feedback (e.g., resources determined using the TPC command). Alternatively, the UE 115-a may determine the resources over which to transmit the periodic CSI report based on a predefined rule. In one example, the predefined rule may indicate a slot offset from a slot index that represents a slot of an associated SPS occasion (e.g., a last slot of an SPS occasions used to receive SP transmissions from the base station 105-a) or from a slot index that represents a slot of an associated HARQ feedback (e.g., a last slot of an SPS occasion used to transmit HARQ feedback responsive of the received SP transmissions).

In some examples, the UE 115-a may determine the CSI refinement information 220 based on measurements of received SP DMRSs 210. The CSI refinement information 220 may refer to updated CSI of a previously transmitted CSI report. For example, the CSI refinement information 220 may be an updated CQI or an updated L1-RSRP report. The UE 115-a may receive SP DMRSs 210 in each downlink SPS occasion in order to decode data signaling received from the base station 105-a during each SPS occasion. In one example, the UE 115-a may determine the CSI refinement information 220 based on measurements of SP DMRSs 210 received during an SPS occasion that the UE 115-a is configured to report CSI in. In another example, the UE 115-a may determine the CSI refinement information 220 based on measurements of DMRSs received during two or more SPS occasions.

As one example, the UE 115-a may not be configured to report CSI in a first SPS occasion, but may be configured to report CSI in a second SPS occasion that occurs after the first occasion. In such example, the UE 115-a may measure DMRSs received during the first SPS occasion and measure SP DMRSs 210 received during the second SPS occasion. The UE 115-a may combine the measurements of the SP DMRSs 210 received during the first SPS occasion and the measurements of the SP DMRSs 210 received during the second SPS occasion and determine the CSI refinement information 220 based on the combination of measurements. In one example, combining the measurement may refer to averaging or applying a temporal filter to the measurements of the SP DMRSs 210 received during the first SPS occasion and the measurements of the SP DMRSs 210 received during the second SPS occasion.

In some examples, when determining the CSI refinement information 220, the UE 115-a may only consider SPS occasions whose detection is successful. For example, the UE 115-a may not be configured to report CSI in a first SPS occasion, but may be configured to report CSI in a second SPS occasion that occurs after the first SPS occasion. In one example, the UE 115-a may not successfully detect data signaling received during the second SPS occasion. That is, a CRC check may not be passed for the second SPS occasion. In such example, the UE 115-a may not use the measurements of the SP DMRSs 210 received during the second SPS occasion to determine the CSI refinement information 220. In the case that the UE 115-a solely uses the measurements of SP DMRSs 210 received during the SPS occasion that the UE 115-a is configured to report CSI (e.g., the second SPS occasion), the UE 115-a may not report CSI in the second SPS occasion. Alternatively, in the case that the UE 115-a uses the measurements of SP DMRSs 210 received during multiple SPS occasions to determine the CSI, the UE 115-a may solely use the measurements of SP DMRS 210 received during the first SPS occasion to determine the CSI that is reported during the second SPS occasion.

In some examples, in addition to DMRS measurements, the UE 115-a may determine the CSI refinement information 220 based on measurements of received SP downlink signaling 215. In some examples, the UE 115-a may receive the SP downlink signaling 215 during an SPS occasion in addition to the SP DMRSs 210. SP downlink signals 215 may refer to data signals (e.g., signaling on a downlink shared channel) or reference signals different from DMRSs (e.g., sounding reference signals (SRSs) or cell-specific reference signals (CRS). The UE 115-a may measure the SP downlink signaling 215 and determine the CSI refinement information 220 based on the measurements of the SP downlink signaling 215. In some examples, when determining the CSI refinement information 220, the UE 115-a may use measurement of SP downlink signaling 215 whose associated TCI state, precoding, or port is equal to that of the SP DMRSs 210.

The methods as described herein may allow a UE 115-a to refine dynamically scheduled CSI reports by using measurements of DMRSs received during SPS occasions. That is, the methods as described herein may allow the UE 115-a to report CSI at the higher frequency without allocating resources for CSI-RS in every subframe for which CSI is reported. In some examples, the CSI refinement information 220 may include an updated value of a parameter that was included in a previously transmitted dynamically scheduled CSI report (e.g., regular CSI report). For example, the CSI refinement information 220 may include an updated value for a previously reported CQI or a previously reported L1-RSRP. In some example, the CSI refinement information 220 may include a quantity of bits that indicate a differential adjustment to the previously report parameter. The quantity of the bits may be one or two bits. In some examples, the methods as described herein may be applicable in scenarios where the SPS lacks a precoding diversity scheme.

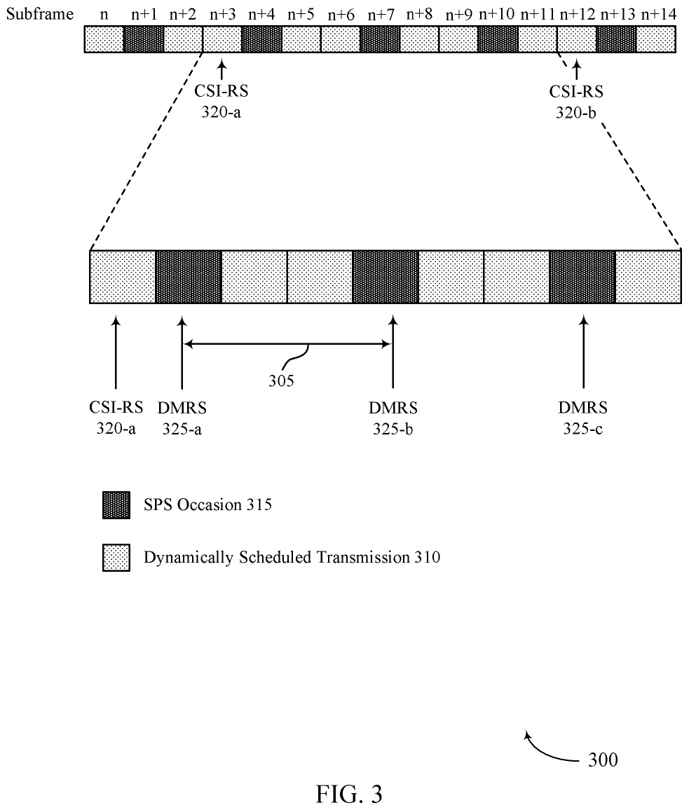

FIG. 3 illustrates an example of a transmission scheme 300 that supports SP CSI report refinement in accordance with aspects of the present disclosure. In some examples, the transmission scheme 300 may implement or be implemented by a wireless communications system 100 and a wireless communications system 200. For example, the transmission scheme 300 may be implemented by a UE 115 and a base station 105 as described with reference to FIGS. 1 and 2.

As described with reference to FIG. 2, a UE may be configured for SPS. In order to implement SPS, the UE may receive a SPS configuration message that includes at least a periodicity 305 for the SPS. The periodicity 305 may indicate a rate at which SPS occasions 315 (e.g., subframes allocated for SPS transmissions) occur. In the example of FIG. 3, the periodicity 305 for the SPS may be two subframes and as such, the SPS occasion 315 may occur every two subframes. For example, as shown in FIG. 3, the SPS occasion 315 may occur at a subframe n+1, a subframe n+4, a subframe n+7, a subframe n+10, and a subframe n+13. The UE may utilize the remaining subframes (e.g., a subframe n, a subframe n+2, a subframe n+3, a subframe n+5, a subframe n+6, a subframe n+8, a subframe n+9, a subframe n+11, a subframe n+12, and a subframe n+14) for dynamically scheduled transmissions 310. In some examples, the UE may not implement SPS until receiving an activation message from the base station. Additionally, the UE may not cease implementation of SPS until receiving a deactivation message from the base station. The activation message may be received in the first subframe including the SPS occasion 315 (e.g., the subframe n+1) and the deactivation message may be received in the last subframe including the SPS occasion 315 (e.g., the subframe n+13).

In some examples, the UE may be configured to transmit a CSI report to the base station. The CSI report may include parameters such as one or more of a CQI, a PMI, a CRI, an SSBRI, a LI, an RI, or an L1-RSRP report. The UE may determine the parameters based on measurements of received CSI-RSs 320 or measurements of received SSB signals. The UE may be configured to transmit the CSI report to the base station in a periodic or aperiodic fashion. In one example, the base station may configure the UE to report CSI at a relatively low periodicity in an effort to save resources. For example, in FIG. 3, the UE may report CSI every eight subframes (e.g., at the subframe n+3 and subframe n+12).

Additionally, as described herein, the base station may configure the UE to report refinement information with respect to a previously transmitted CSI report. In some examples, the refinement information may indicate a change in the parameter included in the previously transmitted CSI report. For example, the refinement information may indicate a change to one or more of the CQI, the PMI, the CRI, the SSBRI, the LI, the RI, or the L1-RSRP report included in the previously transmitted CSI report. In some examples, the refinement information may include a 1 bit or 2 bit indication of a differential adjustment to the parameter. Each logic state (e.g., 0, 1, 00, 10, 01, or 11) may represent a different value for which to increase or decrease a value of the parameter indicated in the previously transmitted CSI report. Alternatively, if the UE has already reported refinement information for a previously transmitted CSI report and is configured to transmit second refinement information for the previously transmitted CSI report (e.g., report refinement information for a second time), the second refinement information may include an indication of a differential adjustment to the previously transmitted refinement information. That is, the UE may consider the parameter included in the previously transmitted CSI report as well as the differential adjustment included in the previously transmitted refinement information when determining the second refinement information.

In some examples, the UE may determine the refinement information based on measurements of received SP downlink signals. For example, the UE may determine the refinement information based on measurements of DMRSs 325. In such example, the UE may measure DMRSs 325 across one or more SPS occasions 315 and determine the refinement information based on the DMRS measurements. In some examples, the UE may be configured with a periodicity at which to transmit the refinement information. In one example, the periodicity for the refinement information may be the same as the periodicity for the SPS occasions 315 indicated in the SPS configuration messages. In such case, the UE may generate refinement information at the subframe n+4, the subframe n+7, and the subframe n+10, where the refinement information indicates an adjustment to the parameter of the CSI report transmitted at the subframe n+3. If the periodicity of the refinement information is the same as the periodicity of the SPS occasions 315, the UE may generate the refinement information for an SPS occasion 315 based solely on measurements of DMRSs 325 received during the SPS occasions 315. For example, the refinement information generated at the subframe n+4 may be based solely on measurements of the DMRSs 325-a, the refinement information generated at the subframe n+7 may be based solely on measurements of the DMRSs 325-b, and the refinement information generated at the subframe n+10 may be based solely on the measurements of the DMRSs 325-c.

Alternatively, the periodicity for the refinement information may be a scaled version of the periodicity of the SPS occasions 315 indicated in the SPS configuration message. In some examples, the UE may identify a scaling factor and apply the scaling factor to the periodicity for the SPS in order to determine the periodicity for the refinement information. In one example, the UE may identify a scaling factor of 2. In such case, the UE may transmit the refinement information in every other SPS occasion 315. In the example of FIG. 3, the UE may generate refinement information at the subframe n+4 and the subframe n+10, where the refinement information is generated with respect to the CSI report generated at the subframe n+3. If the periodicity of the refinement information is different from the periodicity of the SPS occasions 315, the refinement information may be generated based on measurements of DMRSs 325 received during SPS occasions 315 between two instances of CSI refinement. For example, the refinement information generated at the subframe n+10 may be based on the measurements of the DMRSs 325-b received during the subframe n+7 and the measurements of the DMRSs 325-c received during the subframe n+10. In some examples, the UE may combine measurements of the DMRSs 325-b and the DMRSs 325-c (e.g., average the measurements or apply a temporal filter to the measurements) and determine the refinement information based on the combination. In some examples, the periodicity of the refinement information may be included in the SPS configuration message.

In some examples, the UE may consider DMRS measurements of SPS occasions 315 whose detection is successful and may not consider DMRS measurements of SPS occasions 315 whose detection is not successful when determining the refinement information. In one example, the UE may be configured to report refinement information during the SPS occasion 315 at the subframe n+10. If the UE does not detect SP downlink signaling on resources of the SPS occasion 315 at the subframe n+10, the UE may not use the measurements of the received DMRSs 325-c to generate the refinement information. Additionally, if the UE does not utilize DMRS measurements of other SPS occasions 315 (e.g., DMRSs 325-a received during the SPS occasion 315 at subframe n+4 or DMRSs 325-a received during the SPS occasions 315 at the subframe n+7) to generate the refinement information at the subframe n+10 or if the UE does not detect SP downlink signaling on resource of the other SPS occasions, the UE may not generate the refinement information at the subframe n+10. This may be because the UE would have no measurement information (e.g., DMRS measurements) for which to generate the refinement information. In some examples, in addition to measurements of received DMRSs 325, the UE may utilize measurements of other SP downlink signaling to generate the refinement information. In one example, the UE may determine whether to use measurements of SP downlink signaling received during an SPS occasion 315 to generate the refinement information based on a preconfigured or predefined rule. The rule may specify for the UE to use SP downlink signal measurements in addition to the SP DMRS measurements to determine the refinement information for a corresponding SPS occasions 315 if the SP downlink signals and the SP DMRSs are associated with a same TCI state, a same downlink precoding, or a same antenna port.

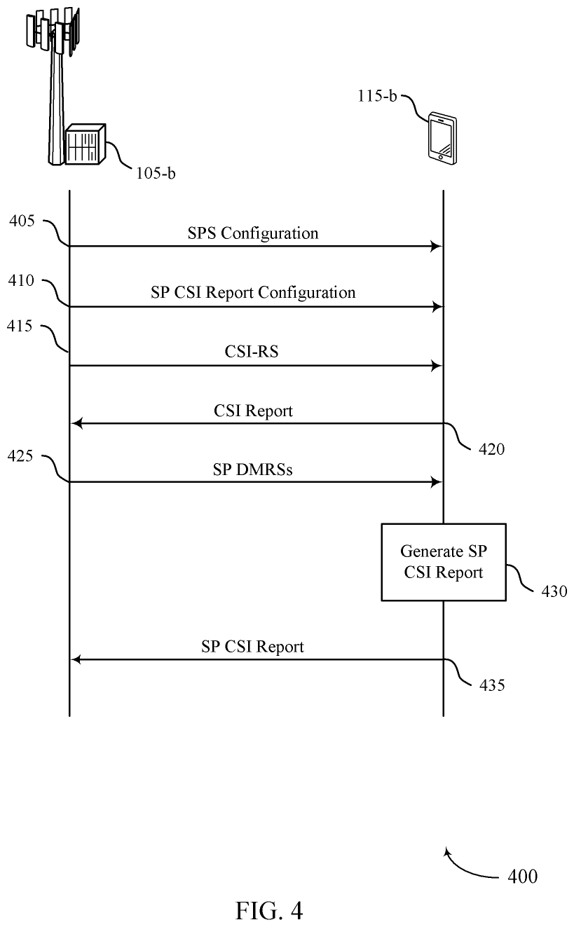

FIG. 4 illustrates an example of a process flow 400 that supports SP CSI report refinement in accordance with aspects of the present disclosure. In some examples, the process flow 400 may implement or be implemented by aspects of a wireless communications system 100 and a wireless communications system 200. For example, the process flow 400 includes a base station 105-b and a UE 115-b which may be examples of a base station 105 and a UE 115 as described in reference to FIGS. 1 and 2. Alternative examples of the following may be implanted, where some steps are performed in a different order then described or are not performed at all. In some cases, steps may include additional features not mentioned below, or further steps may be added.

At 405, the base station 105-b may transmit a SPS configuration message to the UE 115-b. The SPS configuration message may configure the UE with SPS in either a downlink direction or an uplink direction. For downlink SPS, the SPS configuration message may include an SPS C-RNTI, a periodicity for the SPS, or a number of HARQ processes. The periodicity for the SPS may refer to a number of subframes between each SPS occasion (e.g., subframe allocated for SPS transmissions).

At 410, the base station 105-b may transmit an SP CSI report configuration to the UE 115-b. The SP CSI report configuration may indicate for the UE 115-b to transmit a SP CSI report to the base station 105-b. The SP CSI report may include refinement information, where the refinement information indicates a change to a parameters reported in a previously transmitted CSI report (e.g., a CSI report based on dynamically scheduled transmissions). In some examples, the SP CSI report configuration message may be included in the SPS configuration message received at 405. In some examples, the SP CSI report configuration may indicate a periodicity for transmission of the SP CSI report. The periodicity for transmission of the SP CSI report may be based on the periodicity for the SPS indicated in the SPS configuration message received at 405. For example, the periodicity for transmission of the SP CSI report may be equal to the periodicity for SPS. In another example, the periodicity for transmission of the SP CSI report may be based on the periodicity for the SPS and a scaling factor applied to the periodicity for the SPS.

At 415, the UE 115-b may receive one or more CSI-RSs from the base station 105-b. In some examples, the resource over which the base station 105-b transmits the one or more CSI-RSs to the UE 115-b may be dynamically scheduled. That is, the UE 115-b may receive a grant (e.g., via DCI) in a first subframe allocating resources for receiving the one or CSI-RSs in the first subframe.

At 420, the UE 115-b may generate a CSI report based on measurements of the received CSI-RS and transmit the CSI report to the base station 105-b. In some example, the CSI report may include one or more parameters. For example, the CSI report may include a CQI or a L1-RSRP report.

At 425, the UE 115-b may receive one or more SP DMRSs from the base station 105-b. That is, the one or more DMRSs may be received during one or more SPS occasions of a set of SPS occasions. In addition to the one or more SP DMRSs, the UE 115-b may receive one or more other downlink signals. In some examples, the one or more other downlink signals may be SP downlink signals. That is, the one or more downlink signals may be received during the one or more SPS occasions.

At 430, the UE 115-b may generate a SP CSI report including the refinement information. The refinement information may indicate an update to a parameter included in the CSI report transmitted at 420. For example, the refinement information may indicate refinement of the CQI of the previously transmitted CSI report or refinement of an L1-RSRP report of the previously transmitted CSI report. In some examples, the refinement information may include a quantity of bits (e.g., 1 or 2 bits) that indicates a differential adjustment of a with respect to a value of the parameters indicated in the previously transmitted CSI report.

In some examples, the UE 115-b may generate the SP CSI report based on measurements made of the one or more DMRSs during a single SPS occasions of the set of SPS occasions. Alternatively, the UE 115-b may generate the SP CSI report based on measurements made of the one or more DMRSs during two or more SPS occasions of the set of SPS occasions. In some examples, the UE 115-b may combine measurements of DMRSs made of two or more SPS and generate the CSI report based on the combination. Combining the measurements of the DMRSs may include averaging the DMRS measurements or applying a temporal filter to the DMRS measurements. Additionally, the UE 115-b may generate a SP CSI report based on measurements of the one or more other downlink signals received during the set of SPS occasions. In some examples, the UE 115-b may generate a SP CSI report based on downlink signal measurements and DMRS measurements based on one or more conditions being satisfied. The condition may include a TCI state, an antenna port, or a downlink precoding associated with the downlink signals being the same as a TCI state, an antenna port, or a downlink precoding associated with the DMRSs.

At 435, the UE 115-b may transmit the SP CSI report to the base station 105-b. In some examples, the UE 115-b may transmit the SP CSI report to the base station 105-b during a slot that is offset, via an offset value, from one or more SPS occasions or a feedback occasion associated with the one or more SPS occasions. In some examples, the offset value may be indicated to the UE 115-b via the SP CSI report configuration message received at 410. Alternatively, the UE 115-b may transmit the CSI report during a resource allocated for feedback for data signaling received during the one or more SPS occasions.

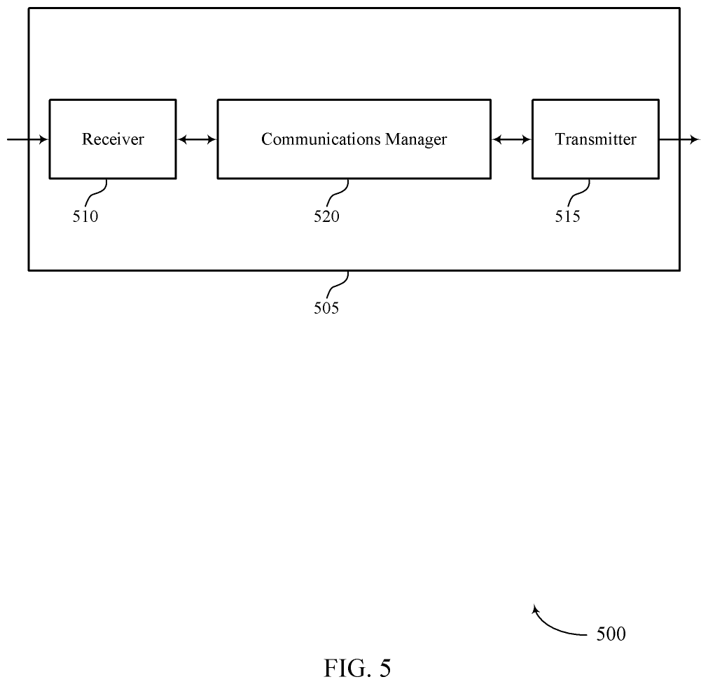

FIG. 5 shows a block diagram 500 of a device 505 that supports SP CSI report refinement in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to SP CSI report refinement). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to SP CSI report refinement). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of SP CSI report refinement as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in hardware, software (e.g., executed by a processor), or any combination thereof. If implemented in code executed by a processor, the functions of the communications manager 520, the receiver 510, the transmitter 515, or various combinations or components thereof may be performed by a general-purpose processor, a DSP, a central processing unit (CPU), a graphics processing unit (GPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving, from a network entity, a message indicating that the UE is to generate a periodic CSI report that includes refinement information with respect to a previously transmitted CSI report. The communications manager 520 may be configured as or otherwise support a means for receiving, from the network entity, one or more DMRSs during one or more SPS occasions of a set of multiple SPS occasions. The communications manager 520 may be configured as or otherwise support a means for transmitting, to the network entity, the periodic CSI report that includes the refinement information, where the refinement information is based on measurements made of the one or more DMRSs.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for more efficient utilization of communication resources. The methods as described herein may allow a device 505 to keep a base station updated on CSI as it changes without having to allocate resources for CSI-RSs in every subframe for which the CSI is generated. The freed up CSI-RS resources may be allocated for different signaling resulting in a more efficient use of resources.

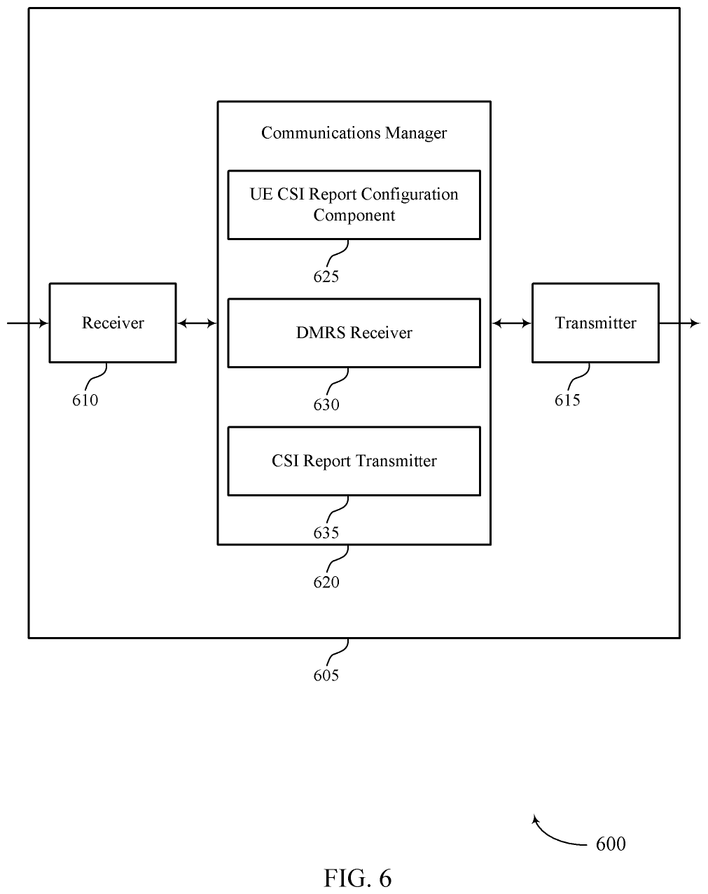

FIG. 6 shows a block diagram 600 of a device 605 that supports SP CSI report refinement in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to SP CSI report refinement). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to SP CSI report refinement). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of SP CSI report refinement as described herein. For example, the communications manager 620 may include a UE CSI report configuration component 625, a DMRS receiver 630, a CSI report transmitter 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The UE CSI report configuration component 625 may be configured as or otherwise support a means for receiving, from a network entity, a message indicating that the UE is to generate a periodic CSI report that includes refinement information with respect to a previously transmitted CSI report. The DMRS receiver 630 may be configured as or otherwise support a means for receiving, from the network entity, one or more DMRSs during one or more SPS occasions of a set of multiple SPS occasions. The CSI report transmitter 635 may be configured as or otherwise support a means for transmitting, to the network entity, the periodic CSI report that includes the refinement information, where the refinement information is based on measurements made of the one or more DMRSs.

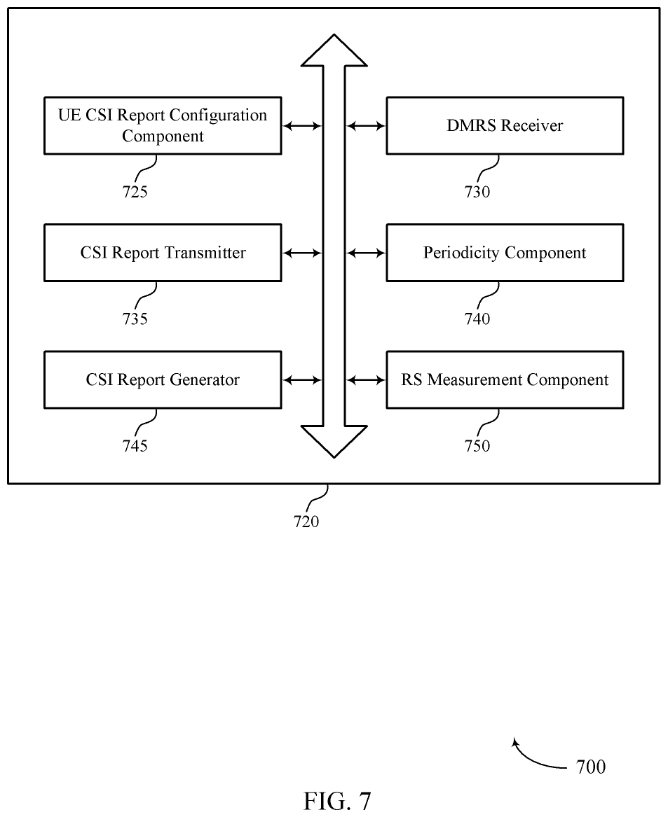

FIG. 7 shows a block diagram 700 of a communications manager 720 that supports SP CSI report refinement in accordance with aspects of the present disclosure. The communications manager 720 may be an example of aspects of a communications manager 520, a communications manager 620, or both, as described herein. The communications manager 720, or various components thereof, may be an example of means for performing various aspects of SP CSI report refinement as described herein. For example, the communications manager 720 may include a UE CSI report configuration component 725, a DMRS receiver 730, a CSI report transmitter 735, a periodicity component 740, a CSI report generator 745, an RS measurement component 750, or any combination thereof. Each of these components may communicate, directly or indirectly, with one another (e.g., via one or more buses).

The communications manager 720 may support wireless communication at a UE in accordance with examples as disclosed herein. The UE CSI report configuration component 725 may be configured as or otherwise support a means for receiving, from a network entity, a message indicating that the UE is to generate a periodic CSI report that includes refinement information with respect to a previously transmitted CSI report. The DMRS receiver 730 may be configured as or otherwise support a means for receiving, from the network entity, one or more DMRSs during one or more SPS occasions of a set of multiple SPS occasions. The CSI report transmitter 735 may be configured as or otherwise support a means for transmitting, to the network entity, the periodic CSI report that includes the refinement information, where the refinement information is based on measurements made of the one or more DMRSs.

In some examples, to support receiving the message indicating that the UE is to generate the periodic CSI report, the UE CSI report configuration component 725 may be configured as or otherwise support a means for receiving signaling that indicates a configuration for the set of multiple SPS occasions, where the configuration includes the message indicating that the UE is to generate the periodic CSI report.

In some examples, to support receiving the message indicating that the UE is to generate the periodic CSI report, the UE CSI report configuration component 725 may be configured as or otherwise support a means for receiving signaling indicating a periodicity for transmission of the periodic CSI report.

In some examples, the periodicity component 740 may be configured as or otherwise support a means for determining a first periodicity for transmission of the periodic CSI report, the first periodicity based on a second periodicity of the set of multiple SPS occasions and a scaling factor to be applied to the second periodicity.

In some examples, the CSI report generator 745 may be configured as or otherwise support a means for generating the periodic CSI report based on measurements made of the one or more DMRSs during a single SPS occasion of the set of multiple SPS occasions.

In some examples, the CSI report generator 745 may be configured as or otherwise support a means for generating the periodic CSI report based on measurements made of the one or more DMRSs during two or more SPS occasions of the set of multiple SPS occasions.

In some examples, to support transmitting the periodic CSI report, the CSI report transmitter 735 may be configured as or otherwise support a means for transmitting the periodic CSI report during a resource allocated for feedback for data signaling received during the one or more SPS occasions.

In some examples, to support transmitting the periodic CSI report, the CSI report transmitter 735 may be configured as or otherwise support a means for transmitting the periodic CSI report during a slot that is offset, via an offset value, from one of the one or more SPS occasions or a feedback occasion associated with the one or more SPS occasions.

In some examples, the CSI report generator 745 may be configured as or otherwise support a means for generating the periodic CSI report based on measurements of the one or more DMRSs that are associated with successful receipt of downlink signaling received during the one or more SPS occasions.

In some examples, the RS measurement component 750 may be configured as or otherwise support a means for measuring at least two DMRSs received during the one or more SPS occasions. In some examples, the RS measurement component 750 may be configured as or otherwise support a means for combining the measurements of the at least two DMRSs, where the refinement information is based on the combining.

In some examples, to support combining the measurements of the at least two DMRSs, the RS measurement component 750 may be configured as or otherwise support a means for averaging the measurements of the at least two DMRSs. In some examples, to support combining the measurements of the at least two DMRSs, the RS measurement component 750 may be configured as or otherwise support a means for applying a temporal filter to the measurements of the at least two DMRSs.

In some examples, the RS measurement component 750 may be configured as or otherwise support a means for measuring one or more downlink signals in addition to the one or more DMRSs during the one or more SPS occasions. In some examples, the CSI report generator 745 may be configured as or otherwise support a means for generating the periodic CSI report based on first measurements made of the one or more downlink signals and on second measurements made of the one or more DMRSs, where inclusion of the first measurements in generation of the periodic CSI report is based on a condition being satisfied.

In some examples, the condition includes a first value of a parameter, the first value associated with the one or more downlink signals, being equal to a second value of the parameter, the second value associated with the one or more DMRSs, the parameter including a TCI state, a type of precoding, or an antenna port.

In some examples, the refinement information includes a quantity of bits, the quantity of bits indicating a differential adjustment of a parameter with respect to a value of the parameter indicated in the previously transmitted CSI report. In some examples, the previously transmitted CSI report is one of a previous periodic report transmitted in accordance with the message or a previous report transmitted in accordance with a CSI configuration separate from the message.

In some examples, the refinement information indicates refinement of a CQI or a reference signal received power report.

In some examples, the CSI report generator 745 may be configured as or otherwise support a means for generating the periodic CSI report based on an absence of precoding diversity schemes being applied to the one or more SPS occasions.

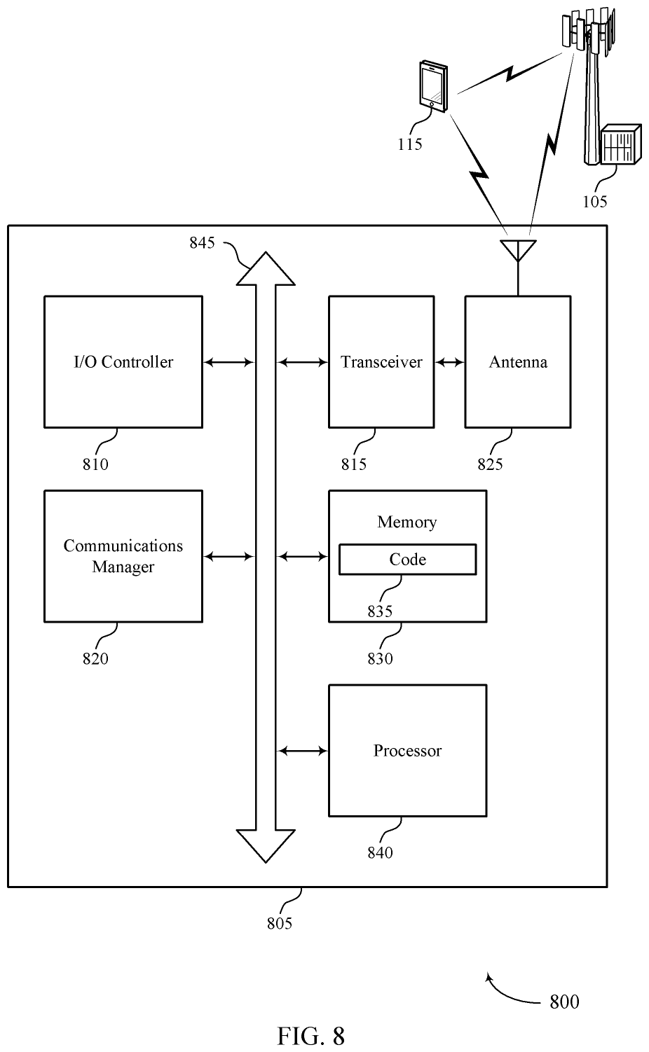

FIG. 8 shows a diagram of a system 800 including a device 805 that supports SP CSI report refinement in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting SP CSI report refinement). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving, from a network entity, a message indicating that the UE is to generate a periodic CSI report that includes refinement information with respect to a previously transmitted CSI report. The communications manager 820 may be configured as or otherwise support a means for receiving, from the network entity, one or more DMRSs during one or more SPS occasions of a set of multiple SPS occasions. The communications manager 820 may be configured as or otherwise support a means for transmitting, to the network entity, the periodic CSI report that includes the refinement information, where the refinement information is based on measurements made of the one or more DMRSs.

By including or configuring the communications manager 820 in accordance with examples as described herein, the device 805 may support techniques for improved communication reliability, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of SP CSI report refinement as described herein, or the processor 840 and the memory 830 may be otherwise configured to perform or support such operations.

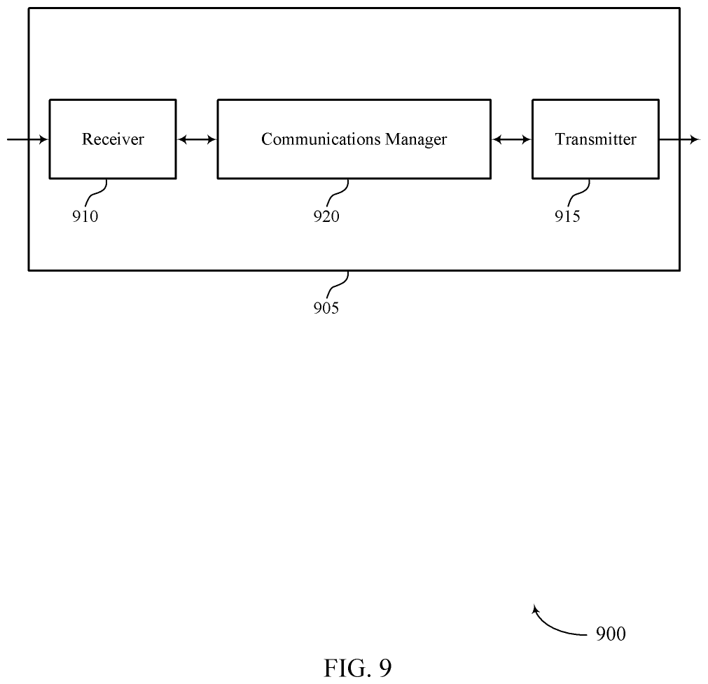

FIG. 9 shows a block diagram 900 of a device 905 that supports SP CSI report refinement in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to SP CSI report refinement). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to SP CSI report refinement). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of SP CSI report refinement as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in hardware, software (e.g., executed by a processor), or any combination thereof. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network entity in accordance with examples as disclosed herein. For example, the communications manager 920 may be configured as or otherwise support a means for outputting a message indicating that a UE is to generate a periodic CSI report that includes refinement information with respect to a previously received CSI report. The communications manager 920 may be configured as or otherwise support a means for outputting one or more DMRSs during one or more SPS occasions of a set of multiple SPS occasions. The communications manager 920 may be configured as or otherwise support a means for obtaining the periodic CSI report that includes the refinement information, where the refinement information is based on measurements made of the one or more DMRSs.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for more efficient utilization of communication resources.

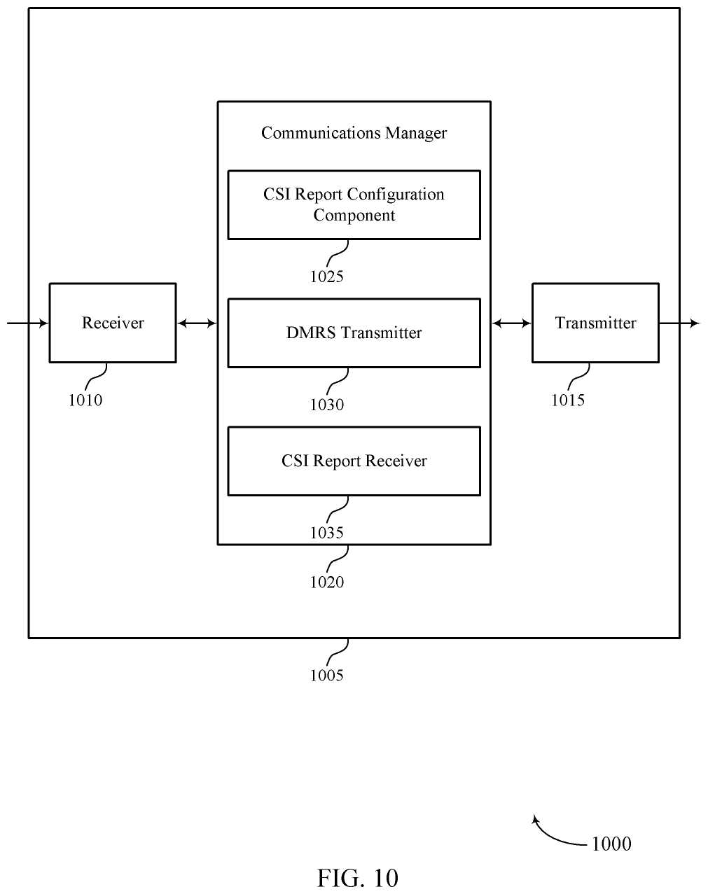

FIG. 10 shows a block diagram 1000 of a device 1005 that supports SP CSI report refinement in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to SP CSI report refinement). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to SP CSI report refinement). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of SP CSI report refinement as described herein. For example, the communications manager 1020 may include a CSI report configuration component 1025, a DMRS transmitter 1030, a CSI report receiver 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network entity in accordance with examples as disclosed herein. The CSI report configuration component 1025 may be configured as or otherwise support a means for outputting a message indicating that a UE is to generate a periodic CSI report that includes refinement information with respect to a previously received CSI report. The DMRS transmitter 1030 may be configured as or otherwise support a means for outputting one or more DMRSs during one or more SPS occasions of a set of multiple SPS occasions. The CSI report receiver 1035 may be configured as or otherwise support a means for obtaining the periodic CSI report that includes the refinement information, where the refinement information is based on measurements made of the one or more DMRSs.

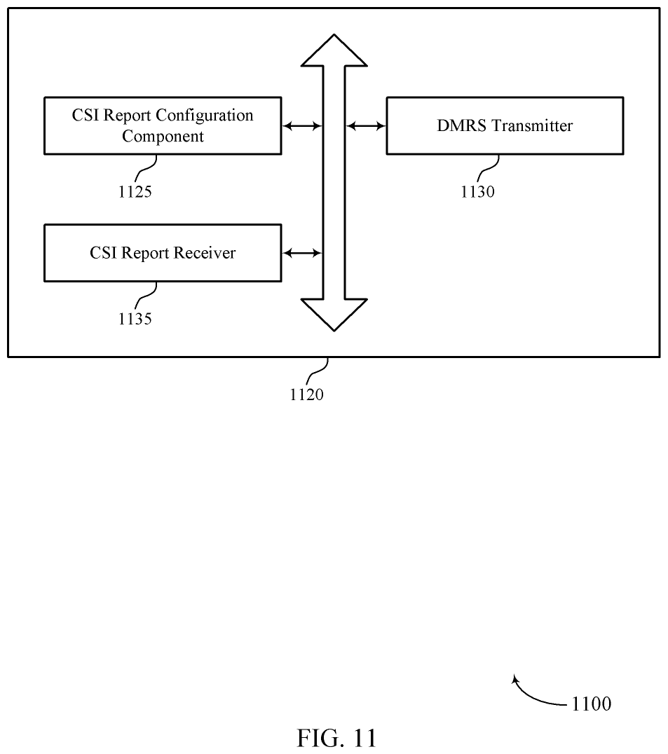

FIG. 11 shows a block diagram 1100 of a communications manager 1120 that supports SP CSI report refinement in accordance with aspects of the present disclosure. The communications manager 1120 may be an example of aspects of a communications manager 920, a communications manager 1020, or both, as described herein. The communications manager 1120, or various components thereof, may be an example of means for performing various aspects of SP CSI report refinement as described herein. For example, the communications manager 1120 may include a CSI report configuration component 1125, a DMRS transmitter 1130, a CSI report receiver 1135, or any combination thereof. Each of these components may communicate, directly or indirectly, with one another (e.g., via one or more buses).

The communications manager 1120 may support wireless communication at a network entity in accordance with examples as disclosed herein. The CSI report configuration component 1125 may be configured as or otherwise support a means for outputting a message indicating that a UE is to generate a periodic CSI report that includes refinement information with respect to a previously received CSI report. The DMRS transmitter 1130 may be configured as or otherwise support a means for outputting one or more DMRSs during one or more SPS occasions of a set of multiple SPS occasions. The CSI report receiver 1135 may be configured as or otherwise support a means for obtaining the periodic CSI report that includes the refinement information, where the refinement information is based on measurements made of the one or more DMRSs.

In some examples, to support outputting the message indicating that the UE is to generate the periodic CSI report, the CSI report configuration component 1125 may be configured as or otherwise support a means for transmitting signaling indicating a configuration for the set of multiple SPS occasions, where the configuration includes the message indicating that the UE is to generate the periodic CSI report.

In some examples, to support outputting the message indicating that the UE is to generate the periodic CSI report, the CSI report configuration component 1125 may be configured as or otherwise support a means for transmitting signaling indicating a periodicity for transmission of the periodic CSI report.

In some examples, a first periodicity for transmission of the periodic CSI report is based on a second periodicity of the set of multiple SPS occasions and a scaling factor to be applied to the second periodicity.

In some examples, the message further indicates that the UE is to generate the periodic CSI report based on measurements made of one or more DMRSs during a single SPS occasion of the set of multiple SPS occasions.

In some examples, the message further indicates that the UE is to generate the periodic CSI report based on measurements made of one or more DMRSs during two or more SPS occasions of the set of multiple SPS occasions.

In some examples, to support obtaining the periodic CSI report, the CSI report receiver 1135 may be configured as or otherwise support a means for receiving the periodic CSI report during a resource allocated for feedback of data signaling received during the one or more SPS occasions.

In some examples, to support obtaining the periodic CSI report, the CSI report receiver 1135 may be configured as or otherwise support a means for receiving the periodic CSI report during a slot that is offset, via a slot offset, from one or more of the one or more SPS occasions or from a feedback occasion associated with the one or more SPS occasions.

In some examples, the message further indicates that the UE is to generate the periodic CSI report based on measurements of the one or more DMRSs that are associated with successful receipt of downlink signaling received during one or more SPS occasions.

In some examples, the refinement information includes a quantity of bits, the quantity of bits indicating a differential adjustment of a parameter with respect to a value of the parameter indicated in the previously received CSI report. In some examples, the previously received CSI report is one of a previous periodic report received in accordance with the message or a previous report received in accordance with a CSI configuration separate from the message.

In some examples, the refinement information indicates refinement of a CQI or a reference signal received power report.

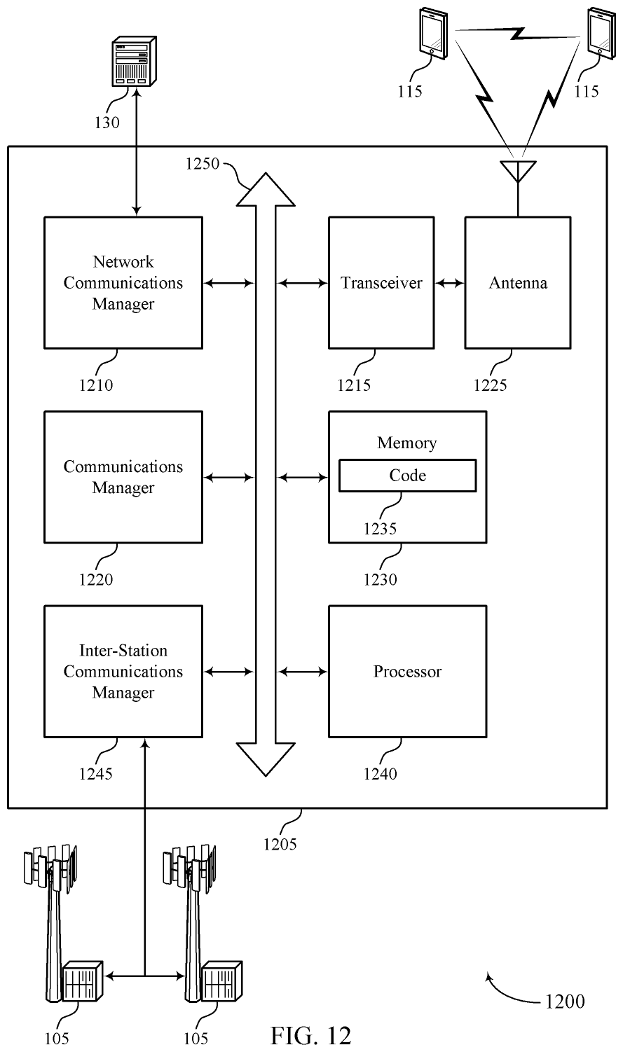

FIG. 12 shows a diagram of a system 1200 including a device 1205 that supports SP CSI report refinement in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting SP CSI report refinement). For example, the device 1205 or a component of the device 1205 may include a processor 1240 and memory 1230 coupled with or to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a network entity in accordance with examples as disclosed herein. For example, the communications manager 1220 may be configured as or otherwise support a means for outputting a message indicating that a UE is to generate a periodic CSI report that includes refinement information with respect to a previously received CSI report. The communications manager 1220 may be configured as or otherwise support a means for outputting one or more DMRSs during one or more SPS occasions of a set of multiple SPS occasions. The communications manager 1220 may be configured as or otherwise support a means for obtaining the periodic CSI report that includes the refinement information, where the refinement information is based on measurements made of the one or more DMRSs.

By including or configuring the communications manager 1220 in accordance with examples as described herein, the device 1205 may support techniques for more efficient utilization of communication resources and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of SP CSI report refinement as described herein, or the processor 1240 and the memory 1230 may be otherwise configured to perform or support such operations.

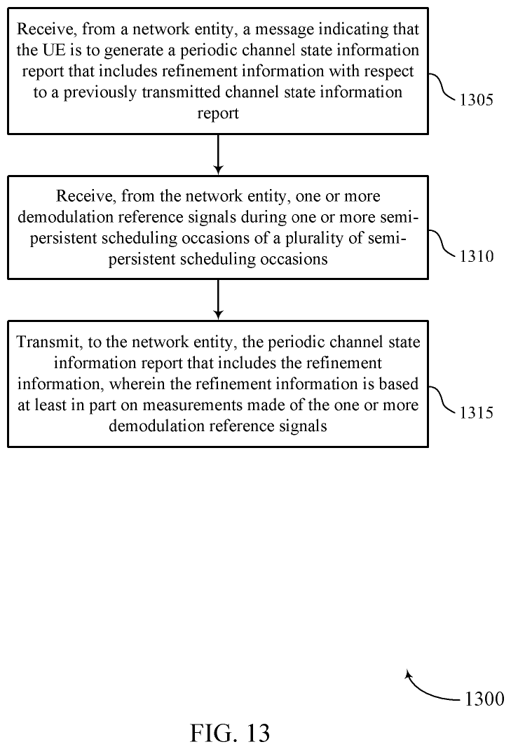

FIG. 13 shows a flowchart illustrating a method 1300 that supports SP CSI report refinement in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a network entity, a message indicating that the UE is to generate a periodic CSI report that includes refinement information with respect to a previously transmitted CSI report. The operations of 1305 may be performed in accordance with examples as disclosed herein. In some examples, aspects of the operations of 1305 may be performed by a UE CSI report configuration component 725 as described with reference to FIG. 7.

At 1310, the method may include receiving, from the network entity, one or more DMRSs during one or more SPS occasions of a set of multiple SPS occasions. The operations of 1310 may be performed in accordance with examples as disclosed herein. In some examples, aspects of the operations of 1310 may be performed by a DMRS receiver 730 as described with reference to FIG. 7.

At 1315, the method may include transmitting, to the network entity, the periodic CSI report that includes the refinement information, wherein the refinement information is based at least in part on measurements made of the one or more DMRSs. The operations of 1315 may be performed in accordance with examples as disclosed herein. In some examples, aspects of the operations of 1315 may be performed by a CSI report transmitter 735 as described with reference to FIG. 7.

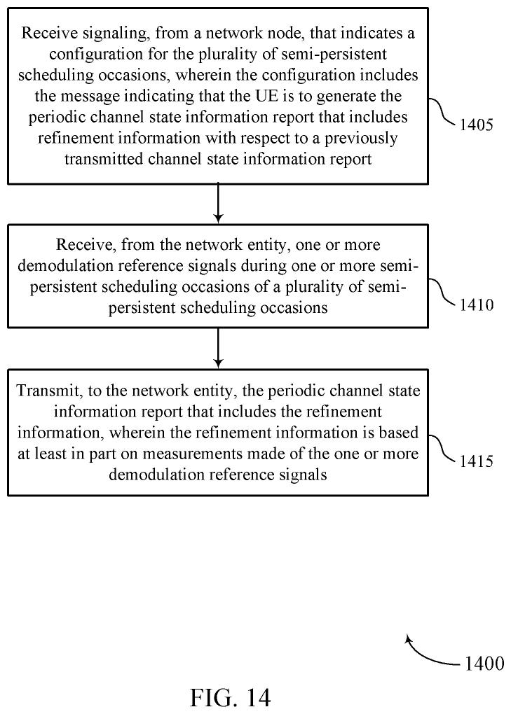

FIG. 14 shows a flowchart illustrating a method 1400 that supports SP CSI report refinement in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a network node, signaling that indicates a configuration for the set of multiple SPS occasions, where the configuration includes the message indicating that the UE is to generate the periodic CSI report that includes refinement information with respect to a previously transmitted CSI report. The operations of 1405 may be performed in accordance with examples as disclosed herein. In some examples, aspects of the operations of 1405 may be performed by a UE CSI report configuration component 725 as described with reference to FIG. 7.

At 1410, the method may include receiving, from the network entity, one or more DMRSs during one or more SPS occasions of a set of multiple SPS occasions. The operations of 1410 may be performed in accordance with examples as disclosed herein. In some examples, aspects of the operations of 1410 may be performed by a DMRS receiver 730 as described with reference to FIG. 7.

At 1415, the method may include transmitting, to the network entity, the periodic CSI report that includes the refinement information, wherein the refinement information is based at least in part on measurements made of the one or more DMRSs. The operations of 1415 may be performed in accordance with examples as disclosed herein. In some examples, aspects of the operations of 1415 may be performed by a CSI report transmitter 735 as described with reference to FIG. 7.

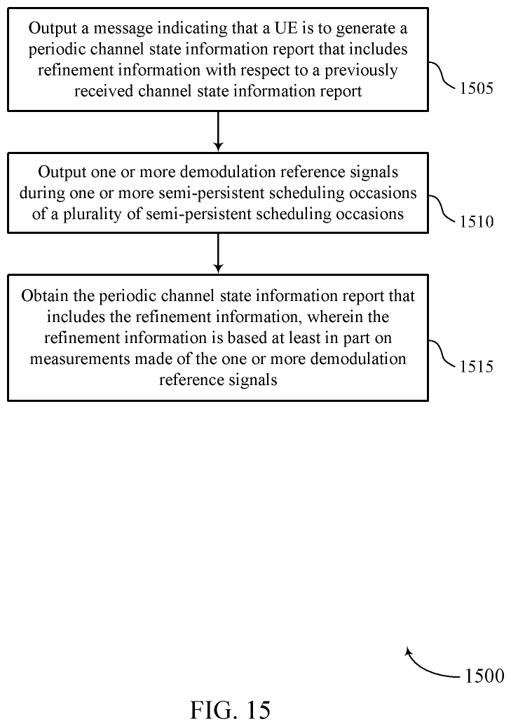

FIG. 15 shows a flowchart illustrating a method 1500 that supports SP CSI report refinement in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include outputting a message indicating that a UE is to generate a periodic CSI report that includes refinement information with respect to a previously received CSI report. The operations of 1505 may be performed in accordance with examples as disclosed herein. In some examples, aspects of the operations of 1505 may be performed by a CSI report configuration component 1125 as described with reference to FIG. 11.

At 1510, the method may include outputting one or more DMRSs during one or more SPS occasions of a set of multiple SPS occasions. The operations of 1510 may be performed in accordance with examples as disclosed herein. In some examples, aspects of the operations of 1510 may be performed by a DMRS transmitter 1130 as described with reference to FIG. 11.

At 1515, the method may include obtaining the periodic CSI report that includes the refinement information, wherein the refinement information is based at least in part on measurements made of the one or more DMRSs. The operations of 1515 may be performed in accordance with examples as disclosed herein. In some examples, aspects of the operations of 1515 may be performed by a CSI report receiver 1135 as described with reference to FIG. 11.

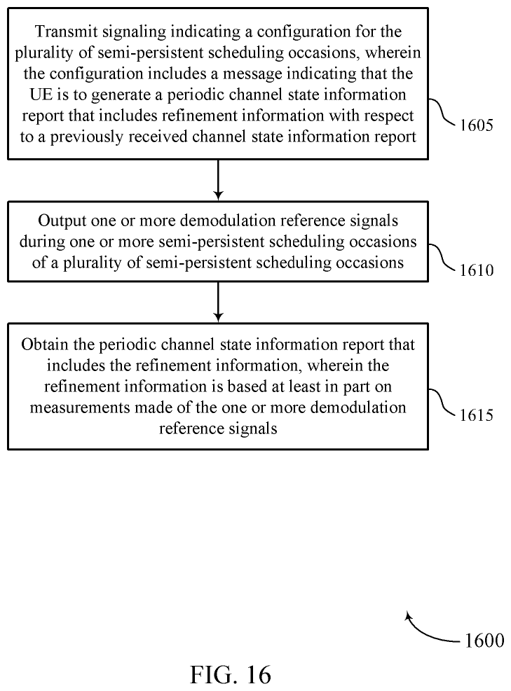

FIG. 16 shows a flowchart illustrating a method 1600 that supports SP CSI report refinement in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting signaling indicating a configuration for the set of multiple SPS occasions, where the configuration includes a message indicating that a UE is to generate a periodic CSI report that includes refinement information with respect to a previously received CSI report. The operations of 1605 may be performed in accordance with examples as disclosed herein. In some examples, aspects of the operations of 1605 may be performed by a CSI report configuration component 1125 as described with reference to FIG. 11.

At 1610, the method may include outputting one or more DMRSs during one or more SPS occasions of a set of multiple SPS occasions. The operations of 1610 may be performed in accordance with examples as disclosed herein. In some examples, aspects of the operations of 1610 may be performed by a DMRS transmitter 1130 as described with reference to FIG. 11.

At 1615, the method may include obtaining the periodic CSI report that includes the refinement information, wherein the refinement information is based at least in part on measurements made of the one or more DMRSs. The operations of 1615 may be performed in accordance with examples as disclosed herein. In some examples, aspects of the operations of 1615 may be performed by a CSI report receiver 1135 as described with reference to FIG. 11.

The following provides an overview of aspects of the present disclosure:
Aspect 1: A method for wireless communication at a UE, comprising: receiving, from a network entity, a message indicating that the UE is to generate a periodic CSI report that includes refinement information with respect to a previously transmitted CSI report; receiving, from the network entity, one or more DMRSs during one or more SPS occasions of a plurality of SPS occasions; and transmitting, to the network entity, the periodic CSI report that includes the refinement information, wherein the refinement information is based at least in part on measurements made of the one or more DMRSs.
Aspect 2: The method of aspect 1, wherein receiving the message indicating that the UE is to generate the periodic CSI report comprises: receiving signaling that indicates a configuration for the plurality of SPS occasions, wherein the configuration includes the message indicating that the UE is to generate the periodic CSI report.
Aspect 3: The method of any of aspects 1 and 2, wherein receiving the message indicating that the UE is to generate the periodic CSI report comprises: receiving signaling indicating a periodicity for transmission of the periodic CSI report.
Aspect 4: The method of any of aspects 1 through 3, further comprising: determining a first periodicity for transmission of the periodic CSI report, the first periodicity based at least in part on a second periodicity of the plurality of SPS occasions and a scaling factor to be applied to the second periodicity.
Aspect 5: The method of any of aspects 1 through 4, further comprising: generating the periodic CSI report based at least in part on measurements made of the one or more DMRSs during a single SPS occasion of the plurality of SPS occasions.
Aspect 6: The method of any of aspects 1 through 4, further comprising: generating the periodic CSI report based at least in part on measurements made of the one or more DMRSs during two or more SPS occasions of the plurality of SPS occasions.
Aspect 7: The method of any of aspects 1 through 6, wherein transmitting the periodic CSI report comprises: transmitting the periodic CSI report during a resource allocated for feedback for data signaling received during the one or more SPS occasions.
Aspect 8: The method of any of aspects 1 through 6, wherein transmitting the periodic CSI report comprises: transmitting the periodic CSI report during a slot that is offset, via an offset value, from one of the one or more SPS occasions or a feedback occasion associated with the one or more SPS occasions.
Aspect 9: The method of any of aspects 1 through 8, further comprising: generating the periodic CSI report based on measurements of the one or more DMRSs that are associated with successful receipt of downlink signaling received during the one or more SPS occasions.
Aspect 10: The method of any of aspects 1 through 9, further comprising: measuring at least two DMRSs received during the one or more SPS occasions; and combining the measurements of the at least two DMRSs, wherein the refinement information is based at least in part on the combining.
Aspect 11: The method of aspect 10, wherein combining the measurements of the at least two DMRSs comprises: averaging the measurements of the at least two DMRSs; or applying a temporal filter to the measurements of the at least two DMRSs.
Aspect 12: The method of any of aspects 1 through 11, further comprising: measuring one or more downlink signals in addition to the one or more DMRSs during the one or more SPS occasions; and generating the periodic CSI report based at least in part on first measurements made of the one or more downlink signals and on second measurements made of the one or more DMRSs, wherein inclusion of the first measurements in generation of the periodic CSI report is based at least in part on a condition being satisfied.
Aspect 13: The method of aspect 12, wherein the condition comprises a first value of a parameter, the first value associated with the one or more downlink signals, being equal to a second value of the parameter, the second value associated with the one or more DMRSs, the parameter comprising a transmission configuration state, a type of precoding, or an antenna port.
Aspect 14: The method of any of aspects 1 through 13, wherein the refinement information comprises a quantity of bits, the quantity of bits indicating a differential adjustment of a parameter with respect to a value of the parameter indicated in the previously transmitted CSI report, the previously transmitted CSI report is one of a previous periodic report transmitted in accordance with the message or a previous report transmitted in accordance with a CSI configuration separate from the message.
Aspect 15: The method of any of aspects 1 through 14, wherein the refinement information indicates refinement of a CQI or a RSRP report.
Aspect 16: The method of any of aspects 1 through 15, further comprising: generating the periodic CSI report based at least in part on an absence of precoding diversity schemes being applied to the one or more SPS occasions.
Aspect 17: A method for wireless communication at a network entity, comprising: outputting a message indicating that a UE is to generate a periodic CSI report that includes refinement information with respect to a previously received CSI report; outputting one or more DMRSs during one or more SPS occasions of a plurality of SPS occasions; and obtaining the periodic CSI report that includes the refinement information, wherein the refinement information is based at least in part on measurements made of the one or more DMRSs.
Aspect 18: The method of aspect 17, wherein outputting the message indicating that the UE is to generate the periodic CSI report comprises: transmitting signaling indicating a configuration for the plurality of SPS occasions, wherein the configuration includes the message indicating that the UE is to generate the periodic CSI report.
Aspect 19: The method of any of aspects 17 through 18, wherein outputting the message indicating that the UE is to generate the periodic CSI report comprises: transmitting signaling indicating a periodicity for transmission of the periodic CSI report.
Aspect 20: The method of any of aspects 17 through 19, wherein a first periodicity for transmission of the periodic CSI report is based at least in part on a second periodicity of the plurality of SPS occasions and a scaling factor to be applied to the second periodicity.
Aspect 21: The method of any of aspects 17 through 20, wherein the message further indicates that the UE is to generate the periodic CSI report based at least in part on measurements made of one or more DMRSs during a single SPS occasion of the plurality of SPS occasions.
Aspect 22: The method of any of aspects 17 through 20, wherein the message further indicates that the UE is to generate the periodic CSI report based at least in part on measurements made of one or more DMRSs during two or more SPS occasions of the plurality of SPS occasions.
Aspect 23: The method of any of aspects 17 through 22, wherein obtaining the periodic CSI report comprises: receiving the periodic CSI report during a resource allocated for feedback of data signaling received during the one or more SPS occasions.
Aspect 24: The method of any of aspects 17 through 22, wherein obtaining the periodic CSI report comprises: receiving the periodic CSI report during a slot that is offset, via a slot offset, from one or more of the one or more SPS occasions or from a feedback occasion associated with the one or more SPS occasions.
Aspect 25: The method of any of aspects 17 through 24, wherein the message further indicates that the UE is to generate the periodic CSI report based on measurements of the one or more DMRSs that are associated with successful receipt of downlink signaling received during one or more SPS occasions.
Aspect 26: The method of any of aspects 17 through 25, wherein the refinement information comprises a quantity of bits, the quantity of bits indicating a differential adjustment of a parameter with respect to a value of the parameter indicated in the previously received CSI report, the previously received CSI report is one of a previous periodic report received in accordance with the message or a previous report received in accordance with a CSI configuration separate from the message.
Aspect 27: The method of any of aspects 17 through 26, wherein the refinement information indicates refinement of a CQI or a RSRP report.
Aspect 28: An apparatus for wireless communication at a UE, comprising at least one processor and memory coupled to the at least one processor, the memory storing instructions executable by the at least one processor to cause the apparatus to perform a method of any of aspects 1 through 16.
Aspect 29: An apparatus for wireless communication at a UE, comprising at least one means for performing a method of any of aspects 1 through 16.
Aspect 30: A non-transitory computer-readable medium storing code for wireless communication at a UE, the code comprising instructions executable by at least one processor to perform a method of any of aspects 1 through 16.
Aspect 31: An apparatus for wireless communication at a network entity, comprising at least one processor and memory coupled to the at least one processor, the memory storing instructions executable by the at least one processor to cause the apparatus to perform a method of any of aspects 17 through 27.
Aspect 32: An apparatus for wireless communication at a network entity, comprising at least one means for performing a method of any of aspects 17 through 27.
Aspect 33: A non-transitory computer-readable medium storing code for wireless communication at a network entity, the code comprising instructions executable by at least one processor to perform a method of any of aspects 17 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, a GPU, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a wide variety of actions and, therefore, “determining” can include calculating, computing, processing, deriving, investigating, looking up (such as via looking up in a table, a database or another data structure), or ascertaining. Also, “determining” can include receiving (such as receiving information) or accessing (such as accessing data in a memory). Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network entity, a message indicating that the UE is to generate a periodic channel state information report that includes refinement information with respect to a previously transmitted channel state information report;
receiving, from the network entity, one or more demodulation reference signals during one or more semi-persistent scheduling occasions of a plurality of semi-persistent scheduling occasions; and
transmitting, to the network entity, the periodic channel state information report that includes the refinement information, wherein the refinement information is based at least in part on measurements made of the one or more demodulation reference signals.

2. The method of claim 1, wherein receiving the message indicating that the UE is to generate the periodic channel state information report comprises:
receiving signaling that indicates a configuration for the plurality of semi-persistent scheduling occasions, wherein the configuration includes the message indicating that the UE is to generate the periodic channel state information report.

3. The method of claim 1, wherein receiving the message indicating that the UE is to generate the periodic channel state information report comprises:
receiving signaling indicating a periodicity for transmission of the periodic channel state information report.

4. The method of claim 1, further comprising:
determining a first periodicity for transmission of the periodic channel state information report, the first periodicity based at least in part on a second periodicity of the plurality of semi-persistent scheduling occasions and a scaling factor to be applied to the second periodicity.

5. The method of claim 1, further comprising:
generating the periodic channel state information report based at least in part on measurements made of the one or more demodulation reference signals during a single semi-persistent scheduling occasion of the plurality of semi-persistent scheduling occasions.

6. The method of claim 1, further comprising:
generating the periodic channel state information report based at least in part on measurements made of the one or more demodulation reference signals during two or more semi-persistent scheduling occasions of the plurality of semi-persistent scheduling occasions.

7. The method of claim 1, wherein transmitting the periodic channel state information report comprises:
transmitting the periodic channel state information report during a resource allocated for feedback for data signaling received during the one or more semi-persistent scheduling occasions.

8. The method of claim 1, wherein transmitting the periodic channel state information report comprises:
transmitting the periodic channel state information report during a slot that is offset, via an offset value, from one of the one or more semi-persistent scheduling occasions or a feedback occasion associated with the one or more semi-persistent scheduling occasions.

9. The method of claim 1, further comprising:
generating the periodic channel state information report based on measurements of the one or more demodulation reference signals that are associated with successful receipt of downlink signaling received during the one or more semi-persistent scheduling occasions.

10. The method of claim 1, further comprising:
measuring at least two demodulation reference signals received during the one or more semi-persistent scheduling occasions; and
combining the measurements of the at least two demodulation reference signals, wherein the refinement information is based at least in part on the combining.

11. The method of claim 10, wherein combining the measurements of the at least two demodulation reference signals comprises:
averaging the measurements of the at least two demodulation reference signals; or
applying a temporal filter to the measurements of the at least two demodulation reference signals.

12. The method of claim 1, further comprising:
measuring one or more downlink signals in addition to the one or more demodulation reference signals during the one or more semi-persistent scheduling occasions; and
generating the periodic channel state information report based at least in part on first measurements made of the one or more downlink signals and on second measurements made of the one or more demodulation reference signals, wherein inclusion of the first measurements in generation of the periodic channel state information report is based at least in part on a condition being satisfied.

13. The method of claim 12, wherein the condition comprises a first value of a parameter, the first value associated with the one or more downlink signals, being equal to a second value of the parameter, the second value associated with the one or more demodulation reference signals, the parameter comprising a transmission configuration indicator state, a type of precoding, or an antenna port.

14. The method of claim 1, wherein:
the refinement information comprises a quantity of bits, the quantity of bits indicating a differential adjustment of a parameter with respect to a value of the parameter indicated in the previously transmitted channel state information report; and
the previously transmitted channel state information report is one of a previous periodic report transmitted in accordance with the message or a previous report transmitted in accordance with a channel state information configuration separate from the message.

15. The method of claim 1, wherein the refinement information indicates refinement of a channel quality index or a reference signal received power report.

16. The method of claim 1, further comprising:
generating the periodic channel state information report based at least in part on an absence of precoding diversity schemes being applied to the one or more semi-persistent scheduling occasions.

17. A method for wireless communication at a network entity, comprising:
outputting a message indicating that a user equipment (UE) is to generate a periodic channel state information report that includes refinement information with respect to a previously received channel state information report;
outputting one or more demodulation reference signals during one or more semi-persistent scheduling occasions of a plurality of semi-persistent scheduling occasions; and
obtaining the periodic channel state information report that includes the refinement information, wherein the refinement information is based at least in part on measurements made of the one or more demodulation reference signals.

18. The method of claim 17, wherein outputting the message indicating that the UE is to generate the periodic channel state information report comprises:
transmitting signaling indicating a configuration for the plurality of semi-persistent scheduling occasions, wherein the configuration includes the message indicating that the UE is to generate the periodic channel state information report.

19. The method of claim 17, wherein outputting the message indicating that the UE is to generate the periodic channel state information report comprises:
transmitting signaling indicating a periodicity for transmission of the periodic channel state information report.

20. The method of claim 17, wherein a first periodicity for transmission of the periodic channel state information report is based at least in part on a second periodicity of the plurality of semi-persistent scheduling occasions and a scaling factor to be applied to the second periodicity.

21. The method of claim 17, wherein the message further indicates that the UE is to generate the periodic channel state information report based at least in part on measurements made of one or more demodulation reference signals during a single semi-persistent scheduling occasion of the plurality of semi-persistent scheduling occasions.

22. The method of claim 17, wherein the message further indicates that the UE is to generate the periodic channel state information report based at least in part on measurements made of one or more demodulation reference signals during two or more semi-persistent scheduling occasions of the plurality of semi-persistent scheduling occasions.

23. The method of claim 17, wherein obtaining the periodic channel state information report comprises:
receiving the periodic channel state information report during a resource allocated for feedback of data signaling received during the one or more semi-persistent scheduling occasions.

24. The method of claim 17, wherein obtaining the periodic channel state information report comprises:
receiving the periodic channel state information report during a slot that is offset, via a slot offset, from one or more of the one or more semi-persistent scheduling occasions or from a feedback occasion associated with the one or more semi-persistent scheduling occasions.

25. The method of claim 17, wherein the message further indicates that the UE is to generate the periodic channel state information report based on measurements of the one or more demodulation reference signals that are associated with successful receipt of downlink signaling received during one or more semi-persistent scheduling occasions.

26. The method of claim 17, wherein:
the refinement information comprises a quantity of bits, the quantity of bits indicating a differential adjustment of a parameter with respect to a value of the parameter indicated in the previously received channel state information report; and
the previously received channel state information report is one of a previous periodic report received in accordance with the message or a previous report received in accordance with a channel state information configuration separate from the message.

27. The method of claim 17, wherein the refinement information indicates refinement of a channel quality index or a reference signal received power report.

28. An apparatus for wireless communication at a user equipment (UE), comprising:
at least one processor; and
memory coupled to the at least on processor, the memory storing instructions executable by the at least one processor to causes the apparatus to:
receive, from a network entity, a message indicating that the UE is to generate a periodic channel state information report that includes refinement information with respect to a previously transmitted channel state information report;
receive, from the network entity, one or more demodulation reference signals during one or more semi-persistent scheduling occasions of a plurality of semi-persistent scheduling occasions; and
transmit, to the network entity, the periodic channel state information report that includes the refinement information, wherein the refinement information is based at least in part on measurements made of the one or more demodulation reference signals.

29. The apparatus of claim 28, wherein the instructions to receive the message indicating that the UE is to generate the periodic channel state information report are executable by the at least one processor to cause the apparatus to:
receive signaling that indicates a configuration for the plurality of semi-persistent scheduling occasions, wherein the configuration includes the message indicating that the UE is to generate the periodic channel state information report.

30. An apparatus for wireless communication at a network entity, comprising:
at least one processor; and
memory coupled with the at least one processor, the memory storing instructions executable by the at least one processor to cause the apparatus to:
output a message indicating that a user equipment (UE) is to generate a periodic channel state information report that includes refinement information with respect to a previously received channel state information report;
output one or more demodulation reference signals during one or more semi-persistent scheduling occasions of a plurality of semi-persistent scheduling occasions; and
obtain the periodic channel state information report that includes the refinement information, wherein the refinement information is based at least in part on measurements made of the one or more demodulation reference signals.
